(19) United States
(12) Patent Application Publication
(10) Pub. No.: US 2007/0175872 A1
(43) Pub. Date: Aug. 2, 2007

(54) Laser back wall protection by particulate shading

(76) Inventors: Lawrence J. Rhoades, Naples, FL (US); James Randall Gilmore, Ligonier, PA (US)

Correspondence Address: IP & INTERNET LAW NORTH, LLC, P.O. BOX 38, ZELIENOPLE, PA, 16063, US

(21) Appl. No.: 11/341,886

(22) Filed: Jan. 27, 2006

(51) Int. Cl. B23K 26/06

(52) U.S. Cl. 219/121.73

(57) ABSTRACT

Methods of preventing ablation damage to a second wall or an underlying second article during the laser drilling of a first wall or an overlying first article are presented. The methods include a step of providing a dry, stable particulate material between the first and second walls or articles to shade the second wall or article from direct laser beam illumination during the laser machining of the first wall or article.

### FIELD OF THE INVENTION

The present invention relates to methods for avoiding ablative damage to the surface of a second wall or back wall during the laser piercing of a first wall or front wall. It is to be understood that the terms “first,” “second,” “front,” and “back” are used herein and in the appended claims as relative terms that relate to a particular laser piercing operation. For example, a “first wall” or “front wall” is the wall that is targeted to be pierced by the laser beam and a “second wall” or “back wall” is the next wall beyond the first or front wall. Thus, what was the first or front wall for the laser drilling of a first hole may become the second or back wall for the laser drilling of a second hole. Further, during the simultaneous laser drilling of two walls A and B, wall A is the front wall with regard to the laser drilling of wall A and at the same time may be the second or back wall with regard to the laser drilling of wall B.

### BACKGROUND OF THE INVENTION

The ability of a laser to drill through many types of materials has been a boon to the development of technology in many areas. For example, laser drilling is used to drill precisely located through holes in fuel injector nozzles, turbine blades, and integrated circuit boards. So effective is laser drilling that a one millimeter thick piece of solid steel can be drilled through in 0.9 seconds with a 30 Watt laser. Once the laser beam has pierced through the intended target, a surface beyond that target can then be damaged in an instant by the emerging laser beam. To make matters worse, it is often necessary after the instant of piercing to continue laser machining the front wall, for example, to shape the sides of a laser drilled hole. This problem is further exacerbated when the laser beam is used to trepan a hole because, after its initial breakthrough, the laser beam must trace the outline of the hole at least once and perhaps several times.

Moreover, in some applications there is almost no allowable tolerance for back wall damage. For example, even a micron size pit may be unacceptable in a diesel fuel injector nozzle fuel chamber wall.

Various schemes have been developed over the years to cope with the problem of backwall strikes, but all have some drawbacks. For example, Patent Cooperation Treaty Publication No. WO 00/69594 of Warner et al., which was published on Nov. 23, 2000, (hereinafter referred to as the '594 publication) notes in its discussion of the background art that it is a common practice to place a solid metal or plastic backing material between the front and back walls to absorb the laser radiation penetrating through the front wall during laser machining. The '594 publication points out that sometimes such materials are simply burned through, thus exposing the back wall to damage and that it is difficult to place solid backing material in the cavities of small parts or those cavities to which there is limited access. The '594 publication also notes that backing materials can melt or be vaporized and then adhere to the cavity surface and that it may difficult to remove the adherent material from the cavity surface.

The '594 publication teaches a method of filling an article cavity with what it sometimes refers to as “liquid backing,” i.e., a laser light absorbing or scattering fluid. The '594 publication teaches that the fluid may be stationary or circulated through the cavity during the laser machining operation. The fluid may be either a liquid that includes a laser light energy absorbing die, a viscous and/or gel-like substance, or a gas. The '594 publication also teaches that a light scattering material may be entrained into the fluid in sufficient concentrations to cause a laser beam entering the cavity through a hole in the front wall to be scattered and diffused in many directions, thus greatly attenuating the intensity of the laser light striking the cavity's back wall. However, these methods have several drawbacks, including the need to prevent overheating of the fluid. Where laser absorbing dies are used, the proper selection of the correct dye concentration is critical. Where scattering particles are used, it is necessary to maintain a sufficient concentration of particles entrained in the portion of the fluid that is in the laser beam path as it emerges from the front wall.

U.S. Pat. No. 6,303,901, to Perry et al., which was issued on Oct. 16, 2001, (hereinafter referred to as the '901 patent), in its discussion of the background art, cautions that the flow of liquids having laser barrier properties is not fast enough in the cavities of small articles, like those of fuel injector nozzles, to avoid laser bleaching of the die, which apparently degrades its laser light absorptiveness. The '901 patent also notes that schemes which fill the article cavity with a non-flowing solid may result in damage to the cavity's surfaces from the heating up of the solid by the absorbed laser energy.

The '901 patent teaches that a laser with an ultra short pulse time on the order of picoseconds can be used for penetrating holes without causing significant back wall damage when operated in a regime in which it removes as little as about 10 nanometers of illuminated surface per pulse. Although this method is purported to prevent back wall damage without a barrier being interposed between the front and back walls, the '901 patent nonetheless describes embodiments employing an ultra short pulse laser in which the article cavity is filled with either a photon absorbing gas or a plasma which is renewed after each laser pulse, a non-Newtonian solid which is pressurized to flow into the penetration hole, or a high viscosity liquid which has a high damage threshold and a laser light diffusing property, e.g., vacuum grease. All of these methods have the drawback of being restricted to use with ultra short pulse lasers. Additionally, the use of a gas or plasma which must be renewed after each pulse presents several technical problems related to gas exchange mechanics as well as possibly interposing significant time delays between each laser pulse.

U.S. Pat. No. 6,365,871 to Knowles et al., which was issued on Apr. 2, 2002, (hereinafter referred to as the '871 patent) also describes back wall protection schemes. The '871 patent describes the prior art as teaching the scheme of placing a solid pin in the cavity to obstruct the laser beam, but notes that debris from the pin may have to be cleared afterwards and the design of the article may make the insertion of a pin into the cavity difficult.

Like the '901 patent, the '871 patent teaches a method which involves a fluid having laser barrier properties. The '871 patent notes that the use of fluids having laser barrier properties is particularly beneficial in that the flow of the fluid is able to remove the heat and the waste from the drilling process. The '871 patent further teaches the need for arranging conditions so that the fluid does not enter into the laser drilled hole during the drilling process. The '871 patent describes a fluid as including anything that flows, such as liquids bearing colloids, gases bearing smoke particles or liquid droplets, or a fluidized bed of carbon, ceramic, or metal particles. Some embodiments taught by the '871 patent also include the use of a solid or fluid separator between the laser drilled hole and the laser barrier fluid to prevent the laser barrier fluid from entering the laser drilled hole. Drawbacks with the fluid-based methods of the '871 patent, however, include the need to carefully balance the pressure on the laser side of the article, which may include the pressure of a gas jet sheathing the laser beam, with the cavity pressure and the capillary pressure engendered by the laser drilled hole so as to prevent the fluid from entering the laser drilled hole during the laser drilling operation. The drawbacks also include the need for circulating the fluid within or through the article cavity during the laser drilling operation.

Another method that has been used to prevent back wall damage is to fill the article cavity with a ceramic casting material slurry and to allow the material to solidify before the laser drilling is begun. After the laser drilling has been completed, the article is exposed to a solvent which, over time, dissolves the casting material. This method has been used, for example, to protect the back walls of hollow turbine blades during the drilling of one side of the blade. This method, however, requires that the article be immune to the corrosive effects of the casting material slurry and of the solvent. The method also significantly lengthens the processing time because the casting material must solidify before laser drilling can be performed and then must be dissolved and rinsed away after the laser drilling has been completed.

### SUMMARY OF THE INVENTION

It is an object of the present invention to provide methods for protecting an article cavity back wall from laser ablation damage that can result when a laser beam pierces through the cavity's front wall. The laser piercing may result from any laser machining operation that involves laser beam machining of the front wall of an article cavity. Two examples of such operations are laser drilling and laser trepanning.

It is also an object of the present invention to overcome one or more of the drawbacks of the prior art methods for providing such protection.

In accordance with the present invention, an article is provided that contains a cavity which is defined in part by a first or front wall and a second or back wall. At least part of the cavity is filled with a dry, stable particulate material, for example, aluminum oxide powder, so that when a laser beam pierces the front wall or otherwise passes through a hole in the front wall, it illuminates at least a portion of the particulate material. The particulate material shades the back wall during the illumination from the laser beam sufficiently to prevent the laser beam from ablating the surface of the back wall. The particles of the particulate material contact adjacent particles. The overlapping of the interparticle interstices of a layer closer to the back wall by particles in a layer closer to the front wall contributes to the shading of the back wall from the laser light entering through the front wall. After the laser machining operation has been completed, the particulate material may be removed from the cavity, e.g., by gravity flow, vacuuming, or gas jet or liquid purging. The particulate material removal may be further assisted, e.g., by applied vibrations or direct mechanical agitation of the particulate material.

In developing the present invention, the inventors discovered the surprising result that flow of the particulates was not necessary to adequately protect the back wall from laser strikes during the machining of a front wall, even for cavity widths as small as 500 microns. The inventors also discovered the surprising results that the particulate material did not damage the cavity walls by overheating and that, in many embodiments, the cavity surface was not at all contaminated with difficult to remove adherent material generated by the laser illumination of the particulate material.

The present invention also finds application in scenarios involving two spatially separated articles in which one article overlies the other to allow the overlying article to be laser machined without causing ablation damage to the underlying article. Embodiments of the present invention which embrace such scenarios include a step of interposing a sufficient amount of a dry, stable particulate material between the overlying and underlying articles so that the particulate material shades the underlying article from illumination by a laser beam piercing the overlying article. Some such embodiments further include a step of containing the interposed particulate material so that it more reliably remains at a preselected location between the articles.

### BRIEF DESCRIPTION OF THE DRAWINGS

The criticality of the features and merits of the present invention will be better understood by reference to the attached drawings. It is to be understood, however, that the drawings are designed for the purpose of illustration only and not as a definition of the limits of the present invention.

FIG. 1 is a schematic representation of an elevational cross-sectional view of a prior art fuel injection nozzle.

FIG. 2 is a schematic representation of an elevational cross-sectional view of the injector tip portion of a prior art fuel injection nozzle.

FIG. 3 is a schematic representation of an embodiment of the present invention depicting a means for biasing the particulate material within the nozzle sac.

FIGS. 4A and 4B illustrate an embodiment of the present invention involving two spatially separated articles.

FIG. 4A is a side elevational view illustrating a first article overlying a second article.

FIG. 4B is a partially cutaway perspective view of the articles shown in FIG. 4A.

### DESCRIPTION OF PREFERRED EMBODIMENTS

In this section, some preferred embodiments of the present invention are described in detail sufficient for one skilled in the art to practice the present invention. It is to be understood, however, that the fact that a limited number of preferred embodiments are described herein does not in any way limit the scope of the present invention as set forth in the appended claims.

For ease of description, a fuel injection nozzle is used in the description of some embodiments of the present invention to exemplify an article which has a cavity defined in part by a first wall and a second wall. However, it is to be understood that the methods of the present invention are not restricted to use with fuel injection nozzles, but may be used with any article which has a cavity defined in part by a first wall and a second wall where the first wall is to be laser machined without laser ablating the second wall. Another example of such an article is a hollow, gas-cooled turbine blade.

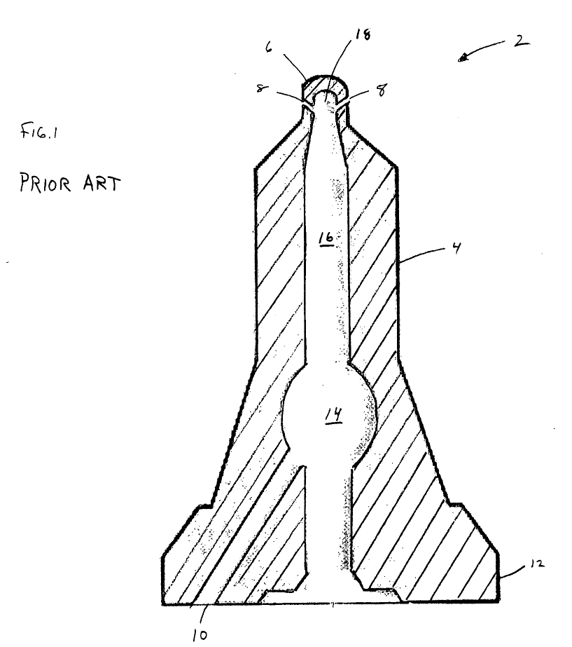

FIG. 1 schematically presents an elevational cross-section of a typical fuel injection nozzle 2. The fuel injection nozzle 2 has a body 4 which is typically made of a stainless steel. The injection end 6 of the fuel injection nozzle 2 during use is inserted into a fuel intake manifold or combustion cylinder where it sprays atomized fuel through nozzle holes 8. Fuel enters the fuel injection nozzle 2 through inlet 10 in the base 12 of the fuel injection nozzle 2 and through bulbous portion 14 then along fuel conduit 16 into the fuel chamber or sac 18 portion of the injection end 6. During use, a metering device (not shown) is present within the conduit 14 and is connected to the engine's electronic control system (not shown). At selected instants, the metering device causes pressurized fuel to spray out through the nozzle holes 8.

In FIG. 1, the relative size of the nozzle holes 8 is exaggerated in order for the nozzle holes 8 to be discernable. In actual fuel injection nozzles, the diameter of the nozzle holes is usually in the range of about 50 to 200 microns, whereas the thickness of the fuel injector wall through which it passes is typically on the order of 1 millimeter.

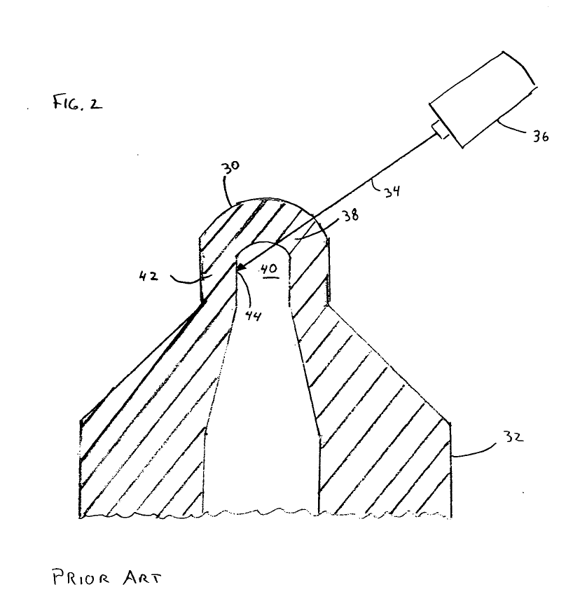

FIG. 2 is a schematic representation of cross-section of the injection end 30 a fuel injection nozzle 32 that has not yet been drilled. The arrow 34 illustrates the path that a laser beam from a laser source 36 would take in laser drilling a nozzle hole into the front wall 38. After emerging from the front wall 38, the laser beam would pass through the cavity or sac 40 and illuminate the back wall 42 at the region 44. Within an instant, the laser beam would cause a crater to be formed by the ablation, i.e., what is sometimes casually referred to as “vaporization,” of a portion of the back wall surface in the region 44. Fuel injection nozzles have little tolerance for back wall damage. Craters having depths as little as 1 micron have been found to degrade the performance of fuel injection nozzles.

In accordance with the present invention, such back wall damage is avoided by placing a dry, stable particulate material into the cavity between the front wall and the back wall so as to shade the back wall from being directly illuminated by a laser beam which pierces the front wall. The term “dry” is used herein and in the appended claims to mean that the particulate material is not suspended in a fluid or non-Newtonian solid nor is it surrounded by a contacting liquid. Rather, in the present invention, the particles of the particulate material have interparticle contact with adjacent other particles of the particulate material.

As used herein and in the appended claims, the term “shade” means to substantially protect an area from direct laser light illumination. The definition of shade embraces both the circumstance wherein the shaded area receives absolutely no direct illumination and the circumstance wherein the shaded area receives some scattered patches of direct illumination which are insufficient, either by themselves or taken together, to cause significant ablation of the shaded area.

The term “stable” when used herein and in the appended claims with reference to particulate material means that, under the expected laser illumination conditions, the particulate material does not either: (1) produce fusion, evaporation, or ablation products that result in significant amounts of difficult to remove contamination of the article surface; or (2) melt, evaporate, ablate, or otherwise transform to such a degree that back wall shading is degraded to the point of insufficiency. Thus, the present invention does not exclude the use of particulate materials that undergo some transformation or degradation when exposed to laser light, so long as those particulate materials meet the criterion stated in the previous sentence.

The particulate material used in embodiments of the present invention is preferably a ceramic, but may be a salt, a glass, or a metal. Preferred particulate materials include: aluminum oxide, boron nitride, mullite, sialon, silicon carbide, zirconium carbide, zirconium oxide, molybdenum, titanium, tungsten, and sodium chloride.

The present invention does not require the particulate material to have good flow properties. Rather, it requires the particulate material only to be transportable into place, whether it be, for example, by gravity flow or by bulk placement of a powder cake. However, it is preferred that the particulate material flow readily under gravity in embodiments wherein the particulate material is to be introduced into and removed from the article cavity by gravity flow.

The present invention includes the use of any shape of particulate material, so long as the particle shape does not interfere with the particle packing to the degree that that the back wall shading afforded is insufficient to prevent back wall damage. Spherical shape is preferred for embodiments in which good flowability is advantageous. The particle surfaces may have any configuration, e.g., they may be smooth, faceted, rough, or convoluted.

The present invention contemplates that the particulate material particle size and the amount of particulate material used be selected with the cavity size taken into consideration so that a sufficient number of particle layers are provided to shade the back wall from the laser light illumination that is expected from the laser piercing of the front wall. Preferably, the particulate material has a multimodal particle size distribution in which the smaller mode size particles fill a majority of the interstices between the next larger mode size particles. Some embodiments of the present invention include the use of particles that are smaller than the size of the hole that is being laser machined into the front wall.

It is preferred that the selection of the particle size take into consideration the manner in which the particulate material is to be introduced into and removed from the article cavity. For example, in embodiments wherein the introduction and removal are to be by gravity flow, it is preferred that particle sizes under 40 microns be avoided, because particles of such a fine size usually have poor flowability.

In general, it is preferred that the median particle size of the particulate material size distribution, on a weight percent basis, be between about 10 and 1,000 micrometers. It is even more preferred that the particle size of the particulate material be between about 100 and 400 micrometers.

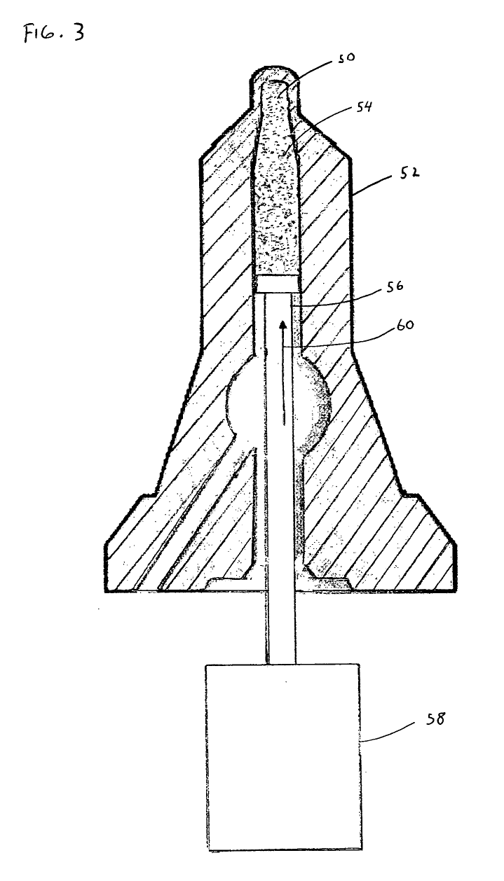

FIG. 3 schematically illustrates an embodiment of the present invention. In this embodiment, the sac 50 of the fuel injection nozzle 52 has been partially filled with a dry, stable particulate material 54. The particulate material 54 is shown as being retained in place by piston 56, but, alternatively, it may be held in place by any suitable means known to one skilled in the art. The piston 56 is shown as being operably connected to a pressure source 58 so that a biasing pressure is maintained on the particulate material 54 during the laser machining operation, as is indicated by arrow 60. Although in some embodiments of the present invention the application of a biasing pressure is not necessary, in many embodiments it is preferred, especially in embodiments wherein the laser beam is ensheathed within a gas jet. Such gas jets are typically used to help remove debris and ablation products from the hole as it is being laser machined. Application of a biasing pressure helps to keep the particulate material 54 from being scattered or pocketed by the gas jet when the laser beam pierces the front wall. The biasing pressure may also help to maintain sufficient particulate material 54 in the laser beam path by particle rearrangement in embodiments wherein some ablation of the particulate material 54 is encountered. The biasing pressure may be applied hydraulically, pneumatically, mechanically, or by any other means known to a person skilled in the art.

In some embodiments of the present invention, vibrations are applied to the article during and/or between laser machining operations to avoid the occurrence of pocketing of the particulate material, i.e., the formation of pockets of open or void areas within the particle bed. Preferably, vibrations are used in conjunction with a biasing pressure, but one may be used without the other. The vibrations may be of any frequency that is suitable for maintaining particulate material shading of the back wall, including ultrasonic frequencies. The vibrations may be applied directly to the article, to the fixturing that holds the article in place, or to an element that is in contact with the particulate material. For example, referring again to FIG. 3, vibrations may be applied to particulate material 54 through piston 56.

In many embodiments of the present invention, the particulate material is not removed from the article cavity until after all of the laser machining operations in which it can provide back wall protection have been completed. However, the present invention also contemplates embodiments in which the particulate material is removed after each laser machining operation and the same or other particulate material is placed in an appropriate location to provide the shading needed for a subsequent laser machining operation. Moreover, the present invention also contemplates embodiments in which the particulate material is not removed from the article cavity even after all laser machining operations have been completed.

In embodiments of the present invention in which the particulate material is to be removed from the article cavity after a laser machining operation, the most preferred method of removal is by gravity flow. However, removal by vacuuming or by purging with a flowing liquid or a gas jet may also be used. The particulate material removal also may be assisted by applied vibrations or direct mechanical agitation of the particulate material.

In some embodiments of the present invention, some agglomeration of the particulate material may result from its exposure to laser illumination during the laser machining operation. The agglomeration may cause the particulate material to be difficult to remove from the article cavity. In such embodiments, a step of at least partially deagglomerating the agglomerates may be employed. The deagglomeration may be accomplished mechanically, for example, by impacting the agglomerates, e.g., with a chisel, or by shearing them, e.g., with a rotating blade. The deagglomeration may also be accomplished by chemical dissolution or by heating the particulate material to melt or otherwise breakup the agglomerates.

The present invention also includes embodiments involving two spatially separated articles in which the first article overlies the second article with respect to a laser beam source to allow the first article to be laser machined without ablation damage occurring to the second article. These embodiments of the present invention include a step of interposing a sufficient amount of a dry, stable particulate material between the articles so that the particulate material shades the second article from being illuminated by a laser beam that pierces the first article. It is to be understood that the second article may be, but need not be, of the same type or quality as the first article. Thus, the second article may be the fixturing or a table used to position or support the first article.

Some such embodiments of the present invention further include a step of containing the interposed particulate material so that it more reliably remains at a preselected location between the articles. For example, the particulate material may be contained within the space between the first and second articles by placing or forming a dam around the area in which the particulate material is to be located.

Some such embodiments of the present invention also include applying a biasing pressure to the particulate material during the laser machining operation in ways which are similar to those described above for other embodiments of the present invention. Vibrations may also be applied to one or both of the articles during and/or between laser machining operations in ways which are similar to those described above for other embodiments of the present invention. Furthermore, all descriptions made above in this section with regard to embodiments of the present invention which involve an article having a cavity defined in part by first and second walls apply also to embodiments of the present invention which involve two spatially separated articles.

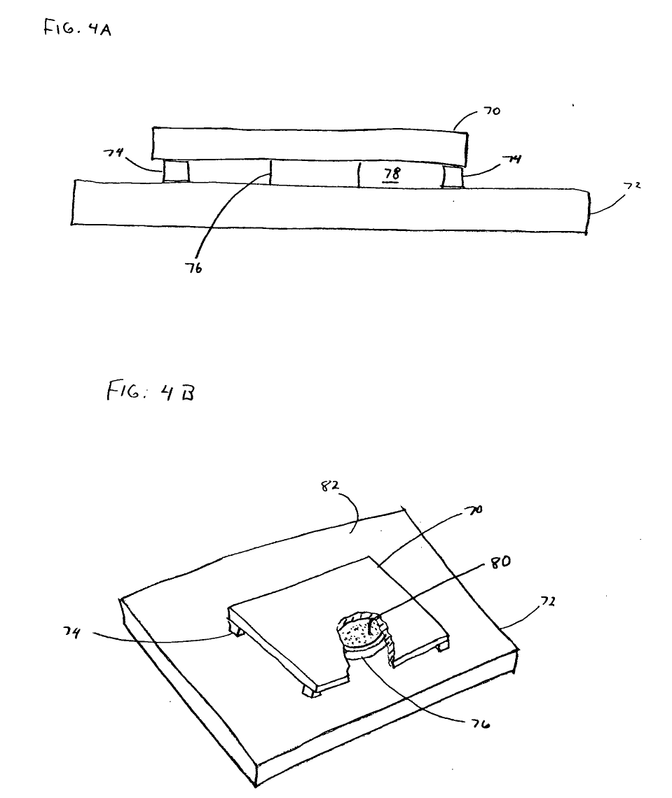

FIGS. 4A and 4B illustrate an embodiment of the present invention which involves two spatially separated articles. FIG. 4A shows a side elevational view wherein a plate 70 is supported above a table 72 by support blocks 74 and a ring 76. Here, the plate 70 is the first article and the table 72 is the second article. The plate 70 and the table 72 are spatially separated by gap 78. As is seen more easily with respect to the partially cut-away perspective view shown in FIG. 4B, the ring 76 is positioned under the portion of the plate 70 that is to be laser machined. The ring 76 contains a bed of dry stable particulate material 80 within gap 78. During the laser machining of the plate 70, the particulate material 80 protects the top surface 82 of the table 72 from ablation damage by shading the top surface 82 from being directly illuminated by the laser beam when it pierces through the plate 70.

The present invention also includes embodiments in which a gas is flowed through the shade-providing particulate material without fluidizing the particulate material. The gas flow may be made at any time before, during, and/or after the laser machining operation, but is preferably made during the laser machining operation. Such a flowing gas may be used to transport away heat or hazardous ablation products caused by the laser machining operation. In some embodiments, the flowing gas may be used to protect the cavity or article surfaces from oxidation. The flowing gas may be introduced to and withdrawn from the particulate material in any manner known to a person skilled in the art.

### EXAMPLES

Tests were conducted to determine the viability of the present invention for providing back wall protection during the laser machining of nozzle holes in fuel injection nozzles. In these tests, commercial diesel fuel injector nozzles were laser machined using a trepanning method to create nozzle holes ranging from about 80 to about 100 micrometers in diameter. The fuel injection nozzle bodies were made of H10 or H11 stainless steel. The wall thickness in the area that was laser drilled was about 1.2 millimeters. The distance between the front and back walls ranged between about 0.5 and about 2.0 millimeters.

The laser used was a 30 watt, NdYAG laser, and was operated at a wavelength of 532 nanometers and produced a laser beam having a 50 micrometer spot size. The laser light was delivered in paired pulses in which the pulse length was between 3 and 5 nanoseconds and the separation time between the two pulses was 100 nanoseconds. The paired pulses were repeated at a rate of 10 kHz.

The laser beam was coaxially surrounded by an air jet which was operated at a pressure of about 207 kPa (30 pounds per square inch). The amount of time the laser was on after it initially pierced the front wall was controlled to be within the range of about 0.2 and about 3.0 seconds. The number of holes consecutively laser drilled in a fuel injector nozzle ranged between 4 and 18. After the laser drilling was completed, the particulate material was removed and the fuel injection nozzles were longitudinally sectioned and visually inspected for back wall damage and for cavity wall surface contamination.

In the tests in which embodiments of the present invention were used, the particulate material was introduced into the sac portion of the fuel injection nozzle by gravity flow and was removed afterwards by gravity flow. The particulate material filled the sac portion to a depth of about 5 millimeters from the nozzle tip. The particulate material was kept in place during the tests by piston which was threaded into the base of the fuel injector and then advanced into the fuel conduit to apply a biasing pressure to the particulate material.

Various types, particle sizes, and particle shapes of particulate material were evaluated. These are identified in TABLE 1.

TABLE 1

| Material Type | Particle Shape | Median Particle Sizes Tested |
|---|---|---|
| Silicon carbide | Faceted | 10 to 1000 micron |
| Silicon carbide | Mulled | 10 to 1000 micron |
| Silicon carbide | Spherical | 10 to 1000 micron |
| Aluminum oxide | Faceted | 10 to 1000 micron |
| Aluminum oxide | Mulled | 10 to 1000 micron |
| Aluminum oxide | Spherical | 10 to 1000 micron |
| Zirconium oxide | Faceted | 10 to 1000 micron |
| Zirconium oxide | Mulled | 10 to 1000 micron |
| Zirconium oxide | Spherical | 10 to 1000 micron |
| SIALON | Faceted | 10 to 1000 micron |
| SIALON | Mulled | 10 to 1000 micron |
| SIALON | Spherical | 10 to 1000 micron |
| Zircon sand | Faceted | 10 to 1000 micron |
| Zircon sand | Mulled | 10 to 1000 micron |
| Zircon sand | Spherical | 10 to 1000 micron |

The results of the tests show that the present invention was successful in preventing any substantial amount of back wall damage. In most cases, absolutely no back wall damage was observed. The results also show that none of the particulate materials tested produced significant amounts difficult to remove contamination of the cavity walls. In many tests, there was no contamination at all.

### Comparative Examples

Comparative tests were conducted using the materials and conditions as described above, except that the fuel injection nozzle sac contained only air. In every such test, severe cratering of the back wall was observed.

While only a few embodiments of the present invention have been shown and described, it will be obvious to those skilled in the art that many changes and modifications may be made thereunto without departing from the spirit and scope of the invention as described in the following claims. All United States patents referred to herein are incorporated herein by reference as if set forth in full herein.

What is claimed is:

1. A method comprising the steps of:
a) providing an article having a cavity defined in part by a first wall and a second wall;
b) filling at least a portion of said cavity with a dry, stable particulate material so that the particles of said particulate material have interparticle contact with adjacent other particles of said particulate material; and
c) illuminating at least a portion of said particulate material by passing a laser beam through a hole in said first wall, said particulate material shading said second wall from the laser beam during said illuminating, wherein said shading prevents said laser beam from ablating a surface of said second wall.

2. The method of claim 1, further comprising the step of applying a pressure to said particulate material, said pressure biasing said particulate material so as to maintain said shading during said step of illuminating.

3. The method of claim 1, further comprising the step of vibrating at least a portion of said particulate material before or during said step of illuminating.

4. The method of claim 3, wherein said step of vibrating includes vibrating at least a portion of said particulate material at an ultrasonic frequency.

5. The method of claim 1, further comprising the step of removing said particulate material from said cavity after said step of illuminating has been completed.

6. The method of claim 5, further comprising the step of agitating said particulate material during said step of removing.

7. The method of claim 5, wherein said step of illuminating agglomerates at least some of the particles of said particulate material into an agglomerate, the method further comprising the step of at least partially deagglomerating said agglomerate.

8. The method of claim 7, wherein said step of deagglomerating is accomplished by stirring said particulate material within said cavity.

9. The method of claim 7, wherein said step of deagglomerating comprises chemically dissolving at least a portion of said agglomerate.

10. The method of claim 1, further comprising the step of retaining the particulate material within the cavity after the step of illuminating has been completed.

11. The method of claim 1, further comprising the step of providing said particulate material with a median particle size in the range of about 10 to about 1,000 micrometers.

12. The method of claim 1, further comprising the step of providing said particulate material with a median particle size in the range of about 100 to about 400 micrometers.

13. The method of claim 1, further comprising the step of providing at least a portion of said particulate material with a spherical shape.

14. The method of claim 1, further comprising the step of providing at least a portion of said particulate material with faceted surfaces.

15. The method of claim 1, further comprising the step of providing at least a portion of said particulate material with a mulled particle shape.

16. The method of claim 1, further comprising the step of providing said particulate material with a multi-modal particle size distribution such that a majority of the interstices between contiguous particles of each relatively larger mode size contains at least one particle of a relatively smaller mode size.

17. The method of claim 1, wherein said particulate material comprises at least one selected from the group consisting of a metal, a ceramic, and a glass.

18. The method of claim 17, wherein said particulate material comprises at least one selected from the group consisting aluminum oxide, boron nitride, mullite, sialon, silicon carbide, zirconium carbide, zirconium oxide, molybdenum, titanium, tungsten, and sodium chloride.

19. The method of claim 1, further comprising the step of flowing a gas through the particulate material without fluidizing the particulate material.

20. The method of claim 1, wherein said article is selected from the group consisting of a fuel injection nozzle and a turbine blade.

21. A method comprising the steps of:
a) spatially separating a first and a second article;
b) placing a dry, stable particulate material in at least a portion of the space between said first and second articles so that the particles of said particulate material have interparticle contact with adjacent other particles of said particulate material; and
c) illuminating at least a portion of said particulate material by passing a laser beam through a hole in said first article, said particulate material shading said second article from the laser beam during said illuminating, wherein said shading prevents said laser beam from ablating a surface of said second article.

22. The method of claim 21, further comprising the step of providing a containing surface around at least a portion of said particulate material.

23. The method of claim 21, further comprising the step of applying a pressure to said particulate material, said pressure biasing said particulate material so as to maintain said shading during said step of illuminating.

24. The method of claim 21, further comprising the step of vibrating at least a portion of said particulate material before or during said step of illuminating.

25. The method of claim 24, wherein said step of vibrating includes vibrating at least a portion of said particulate material at an ultrasonic frequency.

26. The method of claim 21, further comprising the step of removing said particulate material from said cavity after said step of illuminating has been completed.

27. The method of claim 26, further comprising the step of agitating said particulate material during said step of removing.

28. The method of claim 26, wherein said step of illuminating agglomerates at least some of the particles of said particulate material into an agglomerate, the method further comprising the step of at least partially deagglomerating said agglomerate.

29. The method of claim 28, wherein said step of deagglomerating is accomplished by stirring said particulate material.

30. The method of claim 28, wherein said step of deagglomerating comprises chemically dissolving at least a portion of said agglomerate.

31. The method of claim 21, further comprising the step of providing said particulate material with a median particle size in the range of about 10 to about 1,000 micrometers.

32. The method of claim 21, further comprising the step of providing said particulate material with a median particle size in the range of about 100 to about 400 micrometers.

33. The method of claim 21, further comprising the step of providing at least a portion of said particulate material with a spherical shape.

34. The method of claim 21, further comprising the step of providing at least a portion of said particulate material with faceted surfaces.

35. The method of claim 21, further comprising the step of providing at least a portion of said particulate material with a mulled particle shape.

36. The method of claim 21, further comprising the step of providing said particulate material with a multi-modal particle size distribution such that a majority of the interstices between contiguous particles of each relatively larger mode size contains at least one particle of a relatively smaller mode size.

37. The method of claim 21, wherein said particulate material comprises at least one selected from the group consisting of a metal, a ceramic, and a glass.

38. The method of claim 37, wherein said particulate material comprises at least one selected from the group consisting aluminum oxide, boron nitride, mullite, sialon, silicon carbide, zirconium carbide, zirconium oxide, molybdenum, titanium, tungsten, and sodium chloride.

39. The method of claim 21, further comprising the step of flowing a gas through the particulate material without fluidizing the particulate material.
